(19) United States
(12) Patent Application Publication
(10) Pub. No.: US 2020/0114575 A1
(43) Pub. Date: Apr. 16, 2020

(54) ADDITIVE MANUFACTURING OF MULTIPLE MATERIALS WITH NANOPARTICULATE SLURRY PRINTING

(71) Applicant: SABIC GLOBAL TECHNOLOGIES B.V., Bergen op Zoom (KR)

(72) Inventor: Brian Gray PRICE, Evansville, IN (US)

(21) Appl. No.: 16/626,782

(22) PCT Filed: Jun. 27, 2018
(86) PCT No.: PCT/US2018/039729

§ 371 Date: Dec. 26, 2019

Related U.S. Application Data
(60) Provisional application No. 62/525,642, filed on Jun. 27, 2017.

(51) Int. Cl. B29C 64/165; B29C 64/112; B22F 3/00; B29C 64/194; B33Y 10/00; B33Y 70/00

(52) U.S. Cl. CPC B29C 64/165; B29C 64/112; B22F 3/008; B29C 64/194; B22F 2999/00; B33Y 70/00; B22F 2304/05; B22F 2998/10; B33Y 10/00

(57) ABSTRACT

An additive manufacturing method includes: applying a first liquid slurry including a first liquid carrier and polymeric particles onto a substrate as droplets; applying a second liquid slurry including a second liquid carrier and metallic particles onto the substrate as droplets; heating the droplets to substantially evaporate the first liquid carrier from the polymeric particles and the second liquid carrier from the metallic particles; and applying radiant energy to the polymeric particles and the metallic particles to sinter the polymeric particles and the metallic particles. The first liquid slurry and the second liquid slurry are applied onto the substrate as separate slurries, and the polymeric particles and the metallic particles are nanoparticles.

### FIELD OF THE DISCLOSURE

The present disclosure relates to systems and methods of additive manufacturing, and in particular to additive manufacturing of multiple materials with a nanoparticulate printing process.

### BACKGROUND OF THE DISCLOSURE

Additive manufactured articles have traditionally been formed from one material, such as a thermoplastic polymer. It is sometimes advantageous to make the article out of multiple materials, including metals, which may be useful as conductors or structural components.

In a conventional fused deposition molding (FDM) process, articles can be formed from multiple polymeric materials. Metals, however, are not suitable for use in an FDM process in combination with polymeric materials due to the high temperatures typically required for metals in such processes. Further, multiple materials cannot be used in conventional selective deposition sintering (SDS) processes other than by alternating the material in a layer-by-layer fashion. Moreover, SLS processes require the use of substantially more material than is actually required to form the article, and as a result potential for waste is high. Finally, the handling of SLS powers can present a health risk.

These and other shortcomings are addressed by aspects of the present disclosure.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flowchart illustrating an additive manufacturing method according to an aspect of the disclosure.

FIG. 2 is a side view of an additive manufacturing apparatus according to an aspect of the disclosure.

FIGS. 3A and 3B are illustrations of particles formed according to aspects of the disclosure.

FIG. 4 is a side view of an apparatus for applying laser energy to an additively manufactured material according to an aspect of the disclosure.

FIG. 5 is a side view of an additive manufacturing apparatus according to a further aspect of the disclosure.

FIG. 6 is a photograph of a portion of an exemplary additively manufactured part (a scaffold) according to an aspect of the disclosure.

### SUMMARY

Aspects of the disclosure relate to an additive manufacturing method including: applying a first liquid slurry including a liquid carrier and polymeric particles onto a substrate as droplets; applying a second liquid slurry including a second liquid carrier and metallic particles onto the substrate as droplets; heating the droplets to substantially evaporate the first liquid carrier from the polymeric particles and the second liquid carrier from the metallic particles; and applying radiant energy to the polymeric particles and the metallic particles to sinter the polymeric particles and the metallic particles. The first liquid slurry and the second liquid slurry are applied onto the substrate as separate slurries, and the polymeric particles and the metallic particles are nanoparticles.

Aspects of the disclosure further relate to an additive manufacturing method including: forming a metallic nanoparticle scaffold; forming a polymeric article on the metallic nanoparticle scaffold; and heating the metallic nanoparticle scaffold to cause the metallic nanoparticle scaffold to melt into a molten metal form and separate from the polymeric article. Forming a metallic nanoparticle scaffold includes applying a first liquid slurry including a liquid carrier and metallic nanoparticles as first droplets onto a substrate, and heating the first droplets to substantially evaporate the liquid carrier from the metallic nanoparticles and form the metallic nanoparticle scaffold. Forming the polymeric article on the metallic nanoparticle scaffold includes: applying a second liquid slurry including a liquid carrier and polymeric nanoparticles as second droplets onto the metallic nanoparticle scaffold; heating the second droplets to substantially evaporate the liquid carrier from the polymeric nanoparticles; and applying radiant energy to the polymeric nanoparticles to sinter the polymeric nanoparticles and form the polymeric article, the polymeric article being substantially free of polymeric nanoparticles.

Other aspects of the disclosure relate to an additive manufacturing apparatus, including: a print head/nozzle system; a substrate; a physical control system; a heat source; and a radiant energy source. The print head/nozzle system includes at least one print head and at least one nozzle and includes a liquid slurry including a liquid carrier, polymeric particles and metallic particles. The print head/nozzle system applies the liquid slurry onto the substrate as droplets. The heat source heats the droplets to substantially evaporate the liquid carrier from the polymeric particles and the metallic particles. The radiant energy source applies radiant energy to the polymeric particles and the metallic particles to sinter the polymeric particles and the metallic particles. The polymeric particles and the metallic particles are nanoparticles.

### DETAILED DESCRIPTION

The present disclosure can be understood more readily by reference to the following detailed description of the disclosure. In various aspects, the present disclosure relates to an additive manufacturing method including: applying a first liquid slurry including a first liquid carrier and polymeric particles onto a substrate as droplets; applying a second liquid slurry including a second liquid carrier and metallic particles onto the substrate as droplets; heating the droplets to substantially evaporate the first liquid carrier from the polymeric particles and the second liquid slurry from the metallic particles; and applying radiant energy to the polymeric particles and the metallic particles to sinter the polymeric particles and the metallic particles. The first liquid slurry and the second liquid slurry are applied onto the substrate as separate slurries, and the polymeric particles and the metallic particles are nanoparticles.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polymeric particle” includes mixtures of two or more polymeric particles.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “additional optional additives” means that the additives can or cannot be included and the description includes aspects that include and both do not include additional additives.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Additive Manufacturing Methods

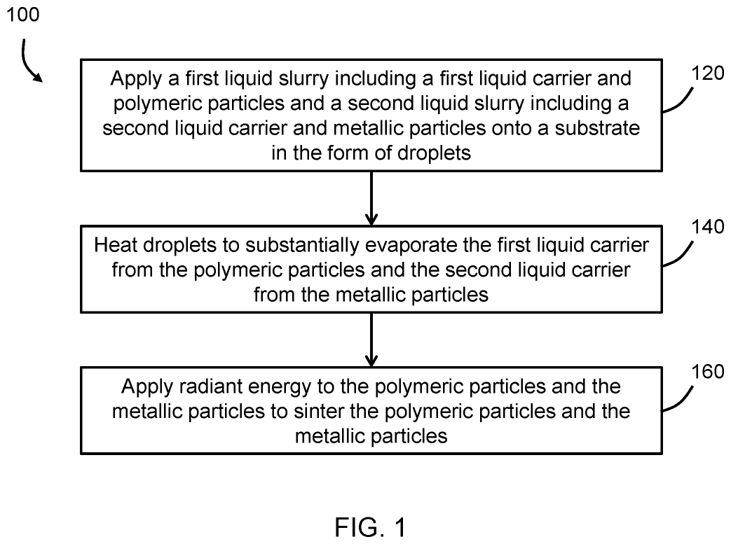

With reference to FIG. 1, aspects of the disclosure relate to an additive manufacturing method 100 including: applying, at step 120, a first liquid slurry including a first liquid carrier and polymeric particles and a second liquid slurry including a second liquid carrier and metallic particles onto a substrate as droplets; heating the droplets to substantially evaporate the first liquid carrier from the polymeric particles and the second liquid carrier metallic particles at step 140; and applying, at step 160, radiant energy to the polymeric particles and the metallic particles to sinter the polymeric particles and the metallic particles. The first liquid slurry and the second liquid slurry are applied onto the substrate as separate slurries, and the polymeric particles and the metallic particles are nanoparticles.

As used herein, “substantially evaporate” means that the respective liquid carriers are completely evaporated or are evaporated from the polymeric particles and the metallic particles to a significant degree such that the amount of liquid carrier remaining with the polymeric particles and the metallic particles will not cause the liquid carrier to vaporize explosively in such a way as to disrupt the positioning of the polymeric particles and/or the metallic particles when the step of applying radiant energy to the polymeric particles and the metallic particles is performed.

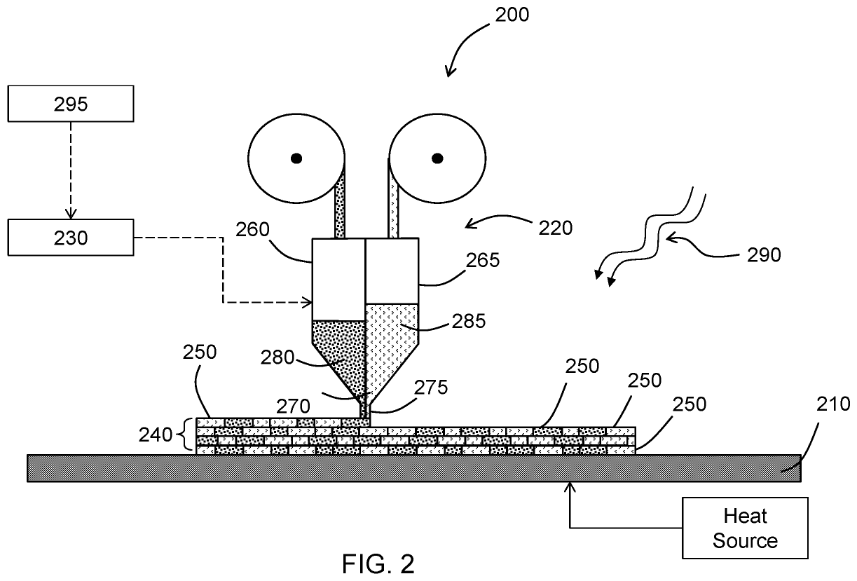

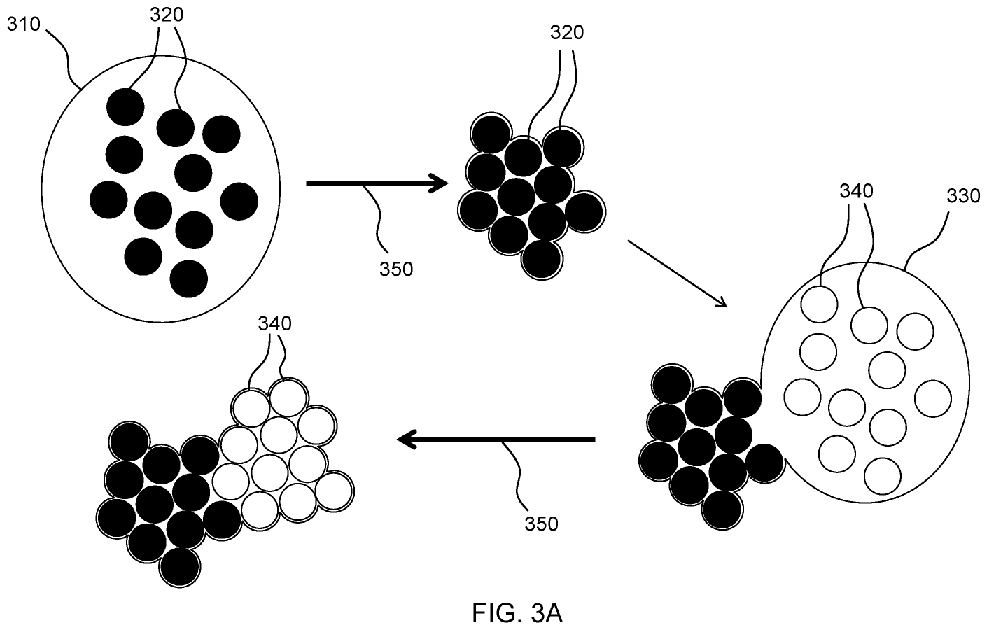

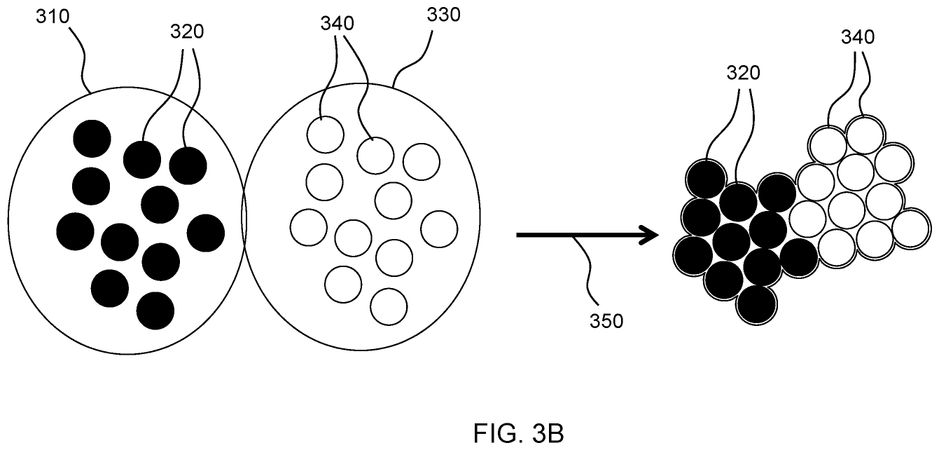

An exemplary additive manufacturing apparatus 200 with which the additive manufacturing method 100 may be performed is illustrated in FIGS. 2 and 3. The apparatus 200 includes a substrate 210, such as, but not limited to, a print bed, a print head/nozzle system 220, and a physical control system 230 providing for relative motion between the print head/nozzle system 220 and the substrate 210. The substrate 210 provides support for a printed part 240 formed by applying one or more layers 250 of a first liquid slurry 280 including a first liquid carrier and polymeric particles, and a second liquid slurry 285 including a second liquid carrier and metallic particles thereon. The substrate 210 may be stationary or movable, as discussed in further detail below. The first liquid carrier may be the same liquid or a different liquid than the second liquid carrier.

The print head/nozzle system 220 includes a first print head 260 and first nozzle 270 within which the first liquid slurry 280 including first droplets including the polymeric particles is located, and a second print head 265 and second nozzle 275 within which the second liquid slurry 285 including second droplets including the metallic particles is located. The print head/nozzle system 220 may be stationary or moveable, as discussed in further detail below. The first print head 260 and the first nozzle 270 apply the first liquid slurry 280 (including the polymeric particles) in a layer 250 onto the substrate 210, and the second print heat 265 and the second nozzle 275 apply the second liquid slurry 285 (including the metallic particles) into the layer 250 onto the substrate 210. In this manner, it is possible to selectively apply the first liquid slurry 280, or the second liquid slurry 285, or both the first liquid slurry 280 and the second liquid slurry 285 in discrete portions of the layer 250 where the particular particles may be desired. It will be recognized that in some aspects more than two print head/nozzle systems may be used to apply more than two slurries (each including the same or different polymeric particles, metallic particles or combinations thereof) in a layer on the substrate. Additional materials may be incorporated into the first liquid slurry 280 and/or the second liquid slurry 285 to enhance the properties of the materials included therein and/or to provide the printed part 240 with additional properties. Purely by way of example, fibers such as carbon nanotubes, graphene or silicon dioxide (SiO₂) nanoparticles may be incorporated into the first liquid slurry 280 and/or the second liquid slurry 285 to improve the strength and thermal stability of the printed part 240.

The first liquid slurry 280 and the second liquid slurry 285 are applied as a layer 250 onto the substrate 210 as droplets. Successive layers 250 may be applied over or onto a previously applied layer 250 to form the printed part 240.

The step 120 of applying the first liquid slurry including the first liquid carrier and polymeric particles and second liquid slurry including the second liquid carrier and the metallic particles onto the substrate as droplets thus may, in some aspects, utilize the additive manufacturing apparatus 200 described above.

The step 140 of heating the droplets to substantially evaporate the first liquid carrier and the second liquid carrier from the polymeric particles and the metallic particles may be performed concurrently with forming the layers 250 described above. In one aspect, the substrate 210 may be heated by a heat source, which will heat the first liquid slurry 280, the second liquid slurry 285, and/or the droplets included therein and cause the liquid carrier to substantially evaporate from the polymeric particles and the metallic particles. In some aspects, the environment 290 around the additive manufacturing apparatus 200 may be heated by a heat source, which will heat the first liquid slurry 280, the second liquid slurry 285 and/or the droplets included therein and cause at least partial evaporation of the first liquid carrier and the second liquid carrier. In further aspects, both the substrate 210 may be heated and the environment 290 may be heated. In some aspects the substrate 210 and/or the environment 290 is heated to a temperature ranging from about ambient temperature to about 250 degrees Celsius (° C.). In particular aspects the substrate 210 and/or the environment 290 is heated to a temperature of from about 50° C. to about 200° C., or from about 50° C. to about 125° C., or from about 75° C. to about 125° C.

As the first liquid carrier evaporates from the first liquid slurry 280 and the second liquid carrier evaporates from the second liquid slurry 285, the droplets in the first liquid slurry and the second liquid slurry contract, causing the polymeric particles and the metallic particles to be pulled together due to capillary forces. This is shown exemplified in FIG. 3A, in which a droplet 310 including, e.g., polymeric particles 320 is applied onto the substrate (as part of a liquid slurry) and application of heat 350 causes at least partial evaporation of the liquid carrier, drawing the polymeric particles 320 together. A neighboring droplet 330 including, e.g., metallic particles 340 is applied onto the substrate (as part of a liquid slurry), and application of the heat 350 causes at least partial evaporation of the liquid carrier, drawing the metallic particles 340 together.

While FIG. 3A shows the droplets being applied one after another, they need not be applied in this manner. For example, with reference to FIG. 3B, a droplet 310 including, e.g., polymeric particles 320 is applied onto the substrate (as part of a liquid slurry) and a droplet 330 including, e.g., metallic particles 340 is applied onto the substrate (as part of a liquid slurry), and application of the heat 350 causes at least partial evaporation of the liquid carrier, drawing the polymeric particles 320 and the metallic particles 340 together. While FIGS. 3A and 3B illustrate droplets including polymeric particles and metallic particles applied proximate one another, it will be recognized that neighboring droplets will include metallic particles proximate other metallic particles and polymeric particles proximate other polymeric particles.

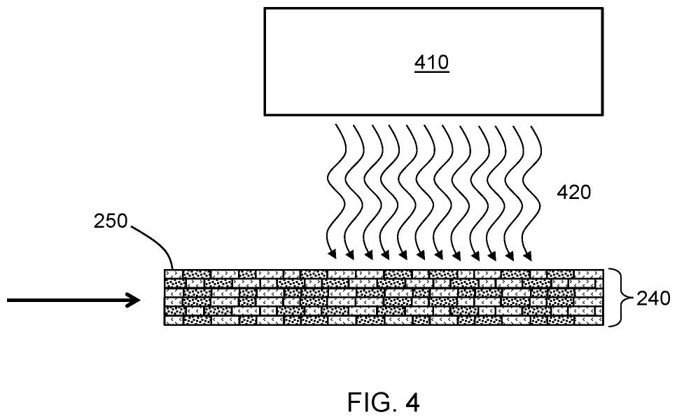

Following at least partial evaporation of the first liquid carrier and the second liquid carrier from the layer 250, radiant energy is applied to the polymeric particles and the metallic particles to sinter the polymeric particles and the metallic particles, at step 160. FIG. 4 shows a radiant energy source 410 applying radiant energy 420 to the printed part 240 including the plurality of layers 250. Any suitable radiant energy source 410 may be used. In some aspects, the radiant energy source emits laser energy or light energy. The radiant energy can have an energy level suitable to sinter the polymeric particles and the metallic particles. In certain aspects the radiant energy has a wavelength of from about 380 nanometers (nm) to about 450 nm.

While FIG. 4 shows the step of applying radiant energy to the polymeric particles and the metallic particles to sinter the polymeric particles and the metallic particles (160) being performed on the printed part 240 after the printed part is formed, the sintering step need not be performed at this stage of production of the printed part 240. In some aspects, for example, laser energy may be applied to each voxel (3D pixel) or some number of voxels as the layer 250 is formed. In such aspects the radiant energy source would be incorporated into an apparatus 200 such as that shown in FIG. 2.

In certain aspects the polymeric particles and the metallic particles have radiant energy absorbance peaks that are relatively comparable to one another, so that when the radiant energy is applied to the polymeric particles and the metallic particles each will be sintered by the radiant energy. In some aspects the absorbance peak of the polymeric particles is within about 75 nanometers (nm) of the absorbance peak of the metallic particles. In particular aspects the absorbance peak of the polymeric particles is within about 50 nm of the absorbance peak of the metallic particles, the absorbance peak of the polymeric particles is within about 25 nm of the absorbance peak of the metallic particles, or the absorbance peak of the polymeric particles is within about 15 nm of the absorbance peak of the metallic particles.

As discussed, the polymeric particles and the metallic particles are nanoparticles. The use of nanoparticles allows the simultaneous additive manufacturing of a mixture of polymeric particles and metallic particles. This is not possible with larger particles due to the difference in melting temperature (i.e., glass transition temperature (T_{g}) of traditional polymeric particles/semicrystalline polymeric particles and melting temperature (Tₘ) of metallic particles/semicrystalline polymeric particles). Traditional polymeric materials used in additive manufacturing applications have a T_{g} in the range of about 90° C. to about 250° C. In contrast, bulk metals typically used in typical SLS processes have a much higher Tₘ, on the order of, e.g., 1000° C. to 1900° C. or more. In particular, polyetherimide (e.g., ULTEM®, available from SABIC), one common polymeric material used in additive manufacturing, has a T_{g} of approximately 204-232° C., and bulk silver has a Tₘ of about 962° C. It has been observed, however, that silver nanoparticles having a particle size of about 20 nm will melt at about 150° C. Polymeric nanoparticles also exhibit a drop in T_{g} as compared to the bulk polymer, although the drop is not as pronounced. The drop in Tₘ between the bulk metal and nanoparticulate metal allows the combined use of polymeric materials and metallic materials in additive manufacturing. In some aspects the nanoparticles have a particle size of from about 10 nanometers (nm) to about 500 nm. In further aspects the polymeric particles have a particle size of from about 10 nm to about 500 nm and the metallic particles have a particle size of from about 10 nm to about 100 nm.

Moreover, by delivering the polymeric particles and the metallic particles in the form of a liquid slurry, the typical handling safety precautions associated with the use of nanoparticulate materials are substantially reduced. The materials could in some aspects be handled throughout their life cycle in slurry form. Moreover, waste may be reduced or eliminated in certain aspects by implementing a print-on-demand type process where the liquid slurry is only placed where it is needed.

The polymeric particles may include any suitable polymeric particles used in additive manufacturing applications. In some aspects, the polymeric particles include, but are not limited to, one or more of acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof. One purely exemplary PEI resin suitable for use in additive manufacturing applications is ULTEM™ resin, available from SABIC.

The metallic particles may include any metal that undergoes a reduction in Tₘ when in nanoparticulate form. In some aspects, the metallic particles include, but are not limited to, one or more of silver, gold, aluminum, tin, iron, copper or a combination thereof.

The first liquid carrier and the second liquid carrier may include any liquid that is suitable for carrying the polymeric particles and the metallic particles in their respective liquid slurries, and that will substantially evaporate from the liquid slurry when heated in accordance with the above disclosure. In certain aspects the first liquid carrier and the second liquid carrier include, but are not limited to, water, alcohol, acetone, or a combination thereof. The first liquid carrier may be the same liquid or a different liquid than the second liquid carrier.

Additional optional additives may be incorporated into the first liquid slurry and the second liquid slurry as desired. In some aspects, the optional additives include, but are not limited to, thermal stabilizers, adhesives, release additives, other desirable materials typically used to improve the properties of additively manufactured articles, and combinations thereof.

The polymeric particles and the metallic particles may be present in their respective liquid slurries in any amount that allows the polymeric particles and the metallic particles to be transported in a liquid slurry and delivered onto the layer 250. In some aspects the polymeric particles are present in the first liquid slurry 280, and the metallic particles are present in the second liquid slurry 285 in a volume fraction of from about 20% to about 50% of polymeric particles or a volume fraction of from about 20% to about 50% of metallic particles.

As discussed, the substrate 210 provides support for a printed part 240 formed by applying one or more layers 250 of a first liquid slurry 280 and a second liquid slurry 285 thereon. In some aspects the substrate includes a thermoplastic polymer. In particular aspects the thermoplastic polymer includes, but is not limited to, acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof. The thermoplastic polymer in the substrate is in some aspects the same polymer as the polymeric particles in the first liquid slurry.

In particular aspects, the thermoplastic polymer in the substrate is in a form of a bed of thermoplastic particles and the first liquid slurry including the polymeric particles and the second liquid slurry including the metallic particles are applied onto the bed of thermoplastic particles. In such applications, the step of applying radiant energy to sinter the polymeric particles and the metallic particles (160) includes sintering the polymeric particles and the metallic particles while they are on (or in) the bed of the thermoplastic particles of the substrate, and then removing the sintered printed part from the substrate. In this manner, it is possible to recover and re-use the thermoplastic particles in the substrate.

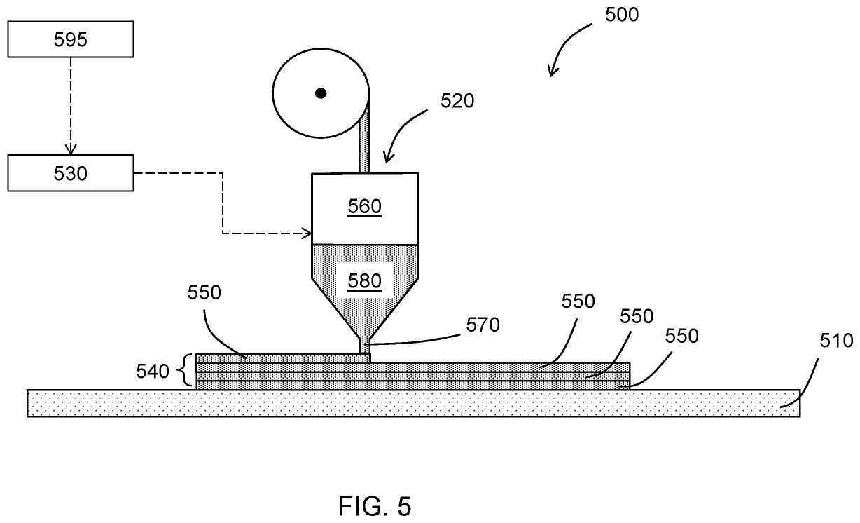

While the exemplary apparatus in FIG. 2 shows the first liquid slurry 280 and the second liquid slurry 285 as being separately dispensed by the print head/nozzle system 220, it will be recognized that the first liquid slurry including the polymeric particles and the second liquid slurry including the metallic particles may be combined in the print head/nozzle system and applied onto the substrate as a combined slurry. Thus, with reference to FIG. 5, aspects of the apparatus 500 include a substrate 510, such as, but not limited to, a print bed, a print head/nozzle system 520, and a physical control system 530 providing for relative motion between the print head/nozzle system 520 and the substrate 510. The substrate 510 provides support for a printed part 540 formed by applying one or more layers 550 of a combined slurry including a first liquid slurry including a first liquid carrier and polymeric particles and a second liquid slurry including a second liquid carrier and metallic particles thereon. The substrate 510 may be stationary or movable, as discussed in further detail below.

The print head/nozzle system 520 includes a print head 560 and nozzle 570 within which the combined slurry 580 including the first liquid carrier, the polymeric particles, the second liquid carrier and the metallic particles are located. The print head 560 and the nozzle 570 apply the combined slurry 580 in a layer 550 onto the substrate 510.

As noted, aspects of the apparatus 200 (FIG. 2) and 500 (FIG. 5) include a physical control system 230/530 providing for relative motion between the print head/nozzle system 220/520 and the substrate 210/510. In some aspects the physical control system 230/530 may be a system, including but not limited to a gear system, a hydraulic system, an electric system, or other suitable system for moving the print head/nozzle system 220/520 while keeping the substrate 210/510 stationary to achieve relative motion between the substrate 210/510 and the print head/nozzle system 220/520. In other aspects the physical control system 230/530 may be a system, including but not limited to a gear system, a hydraulic system, an electric system, or other suitable system for moving the substrate 210/510 while the keeping print head/nozzle system 220/520 stationary to achieve relative motion between the substrate 210/510 and the print head/nozzle system 220/520. As discussed herein, motion refers to a three-dimensional coordinate system having an X-axis, Y-axis and Z-axis that are all perpendicular to one another, and relative motion refers to both horizontal motion along both the X-axis and Y-axis (perpendicular to the print head/nozzle system 220/520) and vertical motion along the Z-axis (parallel to the print head/nozzle system 220/520). The printed part 240/540 is typically printed in a horizontal plane defined by the X-axis and Y-axis (parallel to the substrate 210/510), but it need not be printed in this manner—it could, for example, be printed at an angle relative to the substrate 210/510.

A controller 295/595 receives computer-readable instructions for printing the part 240/540. The computer-readable instructions may be generated by a computer system, and may include, e.g., schematics, diagrams, specifications or other data that would allow the additive manufacturing system to form the printed part 240/540. The computer-readable instructions may include standard information that is known in the art, and in some aspects are provided as a three-dimensional (3D) computer-aided design (CAD) stereolithography (STL) file format or two-dimensional (2D) CAD file which may be converted into an STL file format. The controller 295/595 operates the physical control system 230/530 to print the part 240/540 in accordance with the computer-readable instructions.

### Methods for Making a Scaffold

Aspects of the disclosure further relate to methods for making a scaffold. A scaffold is a porous structure that includes polymeric materials and that may be used as a support structure for certain additive manufacturing parts. Once the part is built on or over the scaffold, the scaffold may be cut away from or otherwise removed from the part.

In certain aspects a method for making a scaffold includes forming a metallic nanoparticle scaffold, forming a polymeric article on the metallic nanoparticle scaffold, and heating the metallic nanoparticle scaffold to cause the metallic nanoparticle scaffold to melt into a molten metal form and separate from the polymeric article. The metallic nanoparticle scaffold is formed by applying a first liquid slurry including a liquid carrier and metallic nanoparticles as first droplets onto a substrate, and heating the first droplets to substantially evaporate the liquid carrier from the metallic nanoparticles and form the metallic nanoparticle scaffold. The polymeric article is formed by: applying a second liquid slurry including a liquid carrier and polymeric nanoparticles as second droplets onto the metallic nanoparticle scaffold; heating the second droplets to substantially evaporate the liquid carrier from the polymeric nanoparticles; and applying radiant energy to the polymeric nanoparticles to sinter the polymeric nanoparticles and form the polymeric article, the polymeric article being substantially free of polymeric nanoparticles. As used herein, “substantially free of polymeric nanoparticles” means that polymeric nanoparticles completely or nearly completely coalesce into larger (i.e., not nano-sized) particles by the sintering process. In some aspects “substantially free of polymeric nanoparticles” means that at least 90%, or at least 95%, or at least 99% of the polymeric nanoparticles coalesce into larger (i.e., not nano-sized) particles by the sintering process.

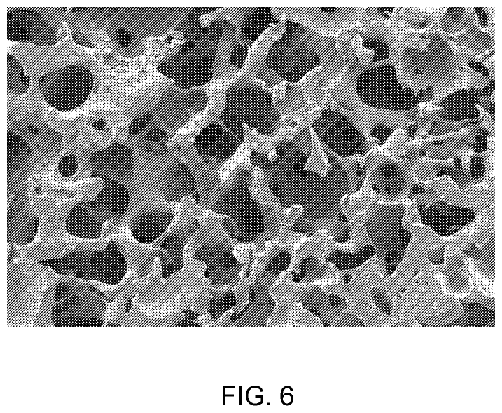

In such a method, the sintering step is applied primarily to the polymeric nanoparticles, causing the polymeric nanoparticles to coalesce and form the polymeric article, while the metallic nanoparticles are substantially unaffected by the sintering process. The metallic nanoparticle scaffold has a high thermal conductivity and thus the ability to rapidly melt. As a result, it can be rapidly heated to melt it away from the polymeric article before the polymeric article is affected. In addition, the molten metal has a much lower viscosity than the polymer, so it will more easily separate from the polymeric article. An exemplary scaffold formed according to the method described herein is illustrated in FIG. 6. Any suitable thermal or radiant treatment could be applied to the metallic nanoparticles to melt them into a molten form. In a particular aspect, the metallic nanoparticles are flash heated to melt them into a molten form.

In certain aspects the molten metal may be reclaimed as it separates from the polymeric article. It can then be re-used in further additive manufacturing or scaffolding processes.

### Other Uses for the Method and Apparatus

In some aspects the methods and apparatus describe herein may be used to improve conductivity of wires or traces in electronic devices. The additive manufacturing process may be used to print a part including polymeric particles and metallic particles in accordance with aspects described herein, wherein the polymeric particles have a higher glass transition temperature than the metallic particles. The step of applying radiant heat to the particles may then be performed using a radiant heat energy level that will selectively sinter only the metallic particles and not the polymeric particles. In such aspects the metallic particles are sintered into a cohesive form having improved conductivity with minimal or no deformation of the polymeric particles.

In yet further aspects the methods described herein may be applied in an electrowetting process. Electrowetting is a process for changing the wetting properties of a surface with an applied electric field. In an aspect of the disclosure, the additive manufacturing method described herein may be applied to a surface of an article to form a conductive surface (e.g., a metallic wire). The conductive surface could be overlaid with a protective coating or layer as desired. An electrical potential could be applied to the conductive surface, which would change the wetting properties of the surface of the article.

It should be appreciated that the present disclosure can include any one up to all of the following aspects:

Aspect 1: An additive manufacturing method comprising, consisting of or consisting essentially of:

applying a first liquid slurry comprising a first liquid carrier and polymeric particles onto a substrate as droplets;

applying a second liquid slurry comprising a second liquid carrier and metallic particles onto the substrate as droplets;

heating the droplets to substantially evaporate the first liquid carrier from the polymeric particles and the second liquid carrier from the metallic particles; and

applying radiant energy to the polymeric particles and the metallic particles to sinter the polymeric particles and the metallic particles,

wherein

the first liquid slurry and the second liquid slurry are applied onto the substrate as separate slurries or as a combined slurry, and

the polymeric particles and the metallic particles are nanoparticles.

Aspect 2: The additive manufacturing method according to aspect 1, wherein the radiant energy is laser energy or light energy.

Aspect 3: The additive manufacturing method according to aspect 1 or 2, wherein the first liquid slurry and the second liquid slurry are applied onto the substrate as separate slurries, and the first liquid slurry comprising the polymeric particles is applied to the substrate before or after the second liquid slurry comprising the metallic particles.

Aspect 4: The additive manufacturing method according to aspect 3, wherein the first droplets are applied to the substrate by a first print head and the second droplets are applied to the substrate by a second print head.

Aspect 5: The additive manufacturing method according to any of aspects 1 to 4, wherein the radiant energy has a wavelength of from about 380 nanometers (nm) to about 450 nm.

Aspect 6: The additive manufacturing method according to any of aspects 1 to 5, wherein the metallic particles comprise silver, gold, aluminum, tin, iron, copper or a combination thereof.

Aspect 7: The additive manufacturing method according to any of aspects 1 to 6, wherein heating the droplets to substantially evaporate the first liquid carrier from the polymeric particles and the second liquid carrier from the metallic particles causes the droplets to contract and the polymeric particles and the metallic particles to be pulled together due to capillary forces.

Aspect 8: The additive manufacturing method according to any of aspects 1 to 7, wherein the first liquid carrier and the second liquid carrier comprise the same liquid or different liquids, and comprise water, alcohol, acetone, or a combination thereof.

Aspect 9: The additive manufacturing method according to any of aspects 1 to 8, wherein the first liquid slurry or the second liquid slurry comprises a volume fraction of about 20% to about 50% polymeric particles or metallic particles.

Aspect 10: The additive manufacturing method according to any of aspects 1 to 9, wherein heating the droplets to substantially evaporate the first liquid carrier from the polymeric particles and the second liquid carrier from the metallic particles comprises heating the substrate to a temperature of from about 50 degrees Celsius (° C.) to about 125° C.

Aspect 11: The additive manufacturing method according to any of aspects 1 to 10, wherein the polymeric particles comprise acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof.

Aspect 12: The additive manufacturing method according to any of aspects 1 to 11, wherein the substrate comprises a thermoplastic polymer.

Aspect 13: The additive manufacturing method according to aspect 12, wherein the thermoplastic polymer comprises acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof.

Aspect 14: The additive manufacturing method according to aspect 12 or 13, wherein the thermoplastic polymer in the substrate is the same polymer as the polymeric particles in the first liquid slurry.

Aspect 15: The additive manufacturing method according to aspect 14, wherein the thermoplastic polymer in the substrate is in a form of a bed of thermoplastic particles, and the first liquid slurry comprising the polymeric particles and the second liquid slurry comprising the metallic particles are applied onto the bed of thermoplastic particles.

Aspect 16: The additive manufacturing method according to any of aspects 1 to 15, wherein the polymeric particles comprise a first absorbance peak and the metallic particles comprise a second absorbance peak, and the first absorbance peak is within about 25 nm of the second absorbance peak.

Aspect 17: The additive manufacturing method according to any of aspects 1 to 16, wherein the method is incorporated into an electrowetting process.

Aspect 18: The additive manufacturing method according to any of aspects 1 to 16, wherein the method is incorporated into a scaffolding process.

Aspect 19: An article formed according to the additive manufacturing method of any of aspects 1 to 18.

Aspect 20: An additive manufacturing method comprising, consisting of or consisting essentially of:

a. forming a metallic nanoparticle scaffold comprising the steps of:
applying a first liquid slurry comprising a liquid carrier and metallic nanoparticles as first droplets onto a substrate; and
heating the first droplets to substantially evaporate the liquid carrier from the metallic nanoparticles and form the metallic nanoparticle scaffold;

b. forming a polymeric article on the metallic nanoparticle scaffold comprising the steps of:
applying a second liquid slurry comprising a liquid carrier and polymeric nanoparticles as second droplets onto the metallic nanoparticle scaffold;
heating the second droplets to substantially evaporate the liquid carrier from the polymeric nanoparticles; and
applying radiant energy to the polymeric nanoparticles to sinter the polymeric nanoparticles and form the polymeric article, wherein the polymeric article is substantially free of polymeric nanoparticles; and

c. heating the metallic nanoparticle scaffold to cause the metallic nanoparticle scaffold to melt into a molten metal form and separate from the polymeric article.

Aspect 21: The additive manufacturing method according to aspect 20, further comprising reclaiming and reusing the molten metal.

Aspect 22: An additive manufacturing apparatus, comprising, consisting of or consisting essentially of:

a print head/nozzle system including at least one print head and at least one nozzle, the print head/nozzle system comprising a liquid slurry comprising a liquid carrier, polymeric particles and metallic particles;

a substrate;

a physical control system;

a heat source; and

a radiant energy source,

wherein

the print head/nozzle system applies the liquid slurry onto the substrate as droplets,

the heat source heats the droplets to substantially evaporate the liquid carrier from the polymeric particles and the metallic particles,

the radiant energy source applies radiant energy to the polymeric particles and the metallic particles to sinter the polymeric particles and the metallic particles, and

the polymeric particles and the metallic particles are nanoparticles.

Aspect 23: The additive manufacturing apparatus according to aspect 22, wherein the radiant energy is laser energy or light energy.

Aspect 24: The additive manufacturing apparatus according to aspect 22 or 23, wherein the liquid slurry comprises a first liquid slurry comprising first droplets comprising the polymeric particles and a second liquid slurry comprising second droplets comprising the metallic particles.

Aspect 25: The additive manufacturing apparatus according to aspect 24, wherein the print head/nozzle system further comprising a first print head and a second print head, and wherein the first droplets are applied to the substrate by the first print head and the second droplets are applied to the substrate by the second print head.

Aspect 26: The additive manufacturing apparatus according to any of aspects 22 to 25, wherein the radiant energy has a wavelength of from about 380 nanometers (nm) to about 450 nm.

Aspect 27: The additive manufacturing apparatus according to any of aspects 22 to 26, wherein the metallic particles comprise silver, gold, aluminum, tin, iron, copper or a combination thereof.

Aspect 28: The additive manufacturing apparatus according to any of aspects 22 to 27, wherein the heat source heats the droplets to substantially evaporate the liquid carrier from the polymeric particles and the metallic particles, causing the droplets to contract and the polymeric particles and the metallic particles to be pulled together due to capillary forces.

Aspect 29: The additive manufacturing apparatus according to any of aspects 22 to 28, wherein the liquid carrier comprises water, alcohol, acetone, or a combination thereof.

Aspect 30: The additive manufacturing apparatus according to any of aspects 22 to 29, wherein the liquid slurry comprises a volume fraction of about 20% to about 50% polymeric particles or metallic particles.

Aspect 31: The additive manufacturing apparatus according to any of aspects 22 to 30, wherein the heat source heats the substrate to a temperature of from about 50° C. to about 125° C.

Aspect 32: The additive manufacturing apparatus according to any of aspects 22 to 31, wherein the polymeric particles comprise acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof.

Aspect 33: The additive manufacturing apparatus according to any of aspects 22 to 32, wherein the substrate comprises a thermoplastic polymer.

Aspect 34: The additive manufacturing apparatus according to aspect 33, wherein the thermoplastic polymer comprises acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof.

Aspect 35: The additive manufacturing apparatus according to aspect 33 or 34, wherein the thermoplastic polymer in the substrate is the same polymer as the polymeric particles in the liquid slurry.

Aspect 36: The additive manufacturing apparatus according to aspect 35, wherein the thermoplastic polymer in the substrate is in a form of a bed of thermoplastic particles, and the liquid slurry comprising the polymeric particles and the metallic particles is applied onto the bed of thermoplastic particles.

Aspect 37: The additive manufacturing apparatus according to any of aspects 22 to 36, wherein the polymeric particles comprise a first absorbance peak and the metallic particles comprise a second absorbance peak, and the first absorbance peak is within about 25 nm of the second absorbance peak.

Aspect 38: An article formed from the additive manufacturing apparatus of any of aspects 22 to 37.

Each of these non-limiting aspects can stand on its own, or can be combined in various permutations or combinations with one or more of the other aspects.

The above detailed description includes references to the accompanying drawings, which form a part of the detailed description. The drawings show, by way of illustration, specific aspects in which the invention can be practiced. Such aspects can include elements in addition to those shown or described. However, the present inventors also contemplate aspects in which only those elements shown or described are provided. Moreover, the present inventors also contemplate aspects using any combination or permutation of those elements shown or described (or one or more aspects thereof), either with respect to a particular aspects (or one or more aspects thereof), or with respect to other aspects (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some aspects can include a computer-readable medium or machine-readable medium encoded with instructions operable to configure an electronic device to perform methods as described in the above aspects. An implementation of such methods can include code, such as microcode, assembly language code, a higher-level language code, or the like. Such code can include computer readable instructions for performing various methods. The code may form portions of computer program products. Further, in an aspect, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An additive manufacturing method comprising:
applying a first liquid slurry comprising a first liquid carrier and polymeric particles onto a substrate as droplets;
applying a second liquid slurry comprising a second liquid carrier and metallic particles onto the substrate as droplets;
heating the droplets to substantially evaporate the first liquid carrier from the polymeric particles and the second liquid carrier from the metallic particles; and
applying radiant energy to the polymeric particles and the metallic particles to sinter the polymeric particles and the metallic particles,
wherein
the first liquid slurry and the second liquid slurry are applied onto the substrate as separate slurries, and
the polymeric particles and the metallic particles are nanoparticles.

2. The additive manufacturing method according to claim 1, wherein the radiant energy is laser energy or light energy.

3. The additive manufacturing method according to claim 1, wherein the first liquid slurry and the second liquid slurry are applied onto the substrate as separate slurries, and the first liquid slurry comprising the polymeric particles is applied to the substrate before or after the second liquid slurry comprising the metallic particles.

4. The additive manufacturing method according to claim 3, wherein the first droplets are applied to the substrate by a first print head and the second droplets are applied to the substrate by a second print head.

5. The additive manufacturing method according to claim 1, wherein the radiant energy has a wavelength of from about 380 nanometers (nm) to about 450 nm.

6. The additive manufacturing method according to claim 1, wherein the metallic particles comprise silver, gold, aluminum, tin, iron, copper or a combination thereof.

7. The additive manufacturing method according to claim 1, wherein heating the droplets to substantially evaporate the first liquid carrier from the polymeric particles and the second liquid carrier from the metallic particles causes the droplets to contract and the polymeric particles and the metallic particles to be pulled together due to capillary forces.

8. The additive manufacturing method according to claim 1, wherein the first liquid carrier and the second liquid carrier comprise the same liquid or different liquids, and comprise water, alcohol, acetone, or a combination thereof.

9. The additive manufacturing method according to claim 1, wherein the first liquid slurry or the second liquid slurry comprises a volume fraction of about 20% to about 50% polymeric particles or metallic particles.

10. The additive manufacturing method according to claim 1, wherein heating the droplets to substantially evaporate the first liquid carrier from the polymeric particles and the second liquid carrier from the metallic particles comprises heating the substrate to a temperature of from about 50 degrees Celsius (° C.) to about 125° C.

11. The additive manufacturing method according to claim 1, wherein the polymeric particles comprise acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof.

12. The additive manufacturing method according to claim 1, wherein the substrate comprises a thermoplastic polymer.

13. The additive manufacturing method according to claim 12, wherein the thermoplastic polymer comprises acrylonitrile butadiene styrene (ABS), polyphenylene sulfide (PPS), polyphenylsulfone (PPSU), polyetheretherketone (PEEK), polyetherimide (PEI), polyphenylene ether (PPE), polycarbonate (PC), and combinations thereof.

14. The additive manufacturing method according to claim 12, wherein the thermoplastic polymer in the substrate is the same polymer as the polymeric particles in the first liquid slurry.

15. The additive manufacturing method according to claim 14, wherein the thermoplastic polymer in the substrate is in a form of a bed of thermoplastic particles, and the first liquid slurry comprising the polymeric particles and the second liquid slurry comprising the metallic particles are applied onto the bed of thermoplastic particles.

16. The additive manufacturing method according to claim 1, wherein the polymeric particles comprise a first absorbance peak and the metallic particles comprise a second absorbance peak, and the first absorbance peak is within about 25 nm of the second absorbance peak.

17. The additive manufacturing method according to claim 1, wherein the method is incorporated into an electrowetting process.

18. The additive manufacturing method according to claim 1, wherein the method is incorporated into a scaffolding process.

19. An article formed according to the additive manufacturing method of claim 1.

20. An additive manufacturing method comprising:
a. forming a metallic nanoparticle scaffold comprising the steps of:
applying a first liquid slurry comprising a liquid carrier and metallic nanoparticles as first droplets onto a substrate; and
heating the first droplets to substantially evaporate the liquid carrier from the metallic nanoparticles and form the metallic nanoparticle scaffold;
b. forming a polymeric article on the metallic nanoparticle scaffold comprising the steps of:
applying a second liquid slurry comprising a liquid carrier and polymeric nanoparticles as second droplets onto the metallic nanoparticle scaffold;
heating the second droplets to substantially evaporate the liquid carrier from the polymeric nanoparticles; and
applying radiant energy to the polymeric nanoparticles to sinter the polymeric nanoparticles and form the polymeric article, wherein the polymeric article is substantially free of polymeric nanoparticles; and
c. heating the metallic nanoparticle scaffold to cause the metallic nanoparticle scaffold to melt into a molten metal form and separate from the polymeric article.
